(19) United States
(12) Patent Application Publication
(10) Pub. No.: US 2017/0314342 A1
(43) Pub. Date: Nov. 2, 2017

(54) CABLE DRAWWORKS FOR A DRILLING RIG

(71) Applicant: Gerald Lesko, Edmonton (CA)

(72) Inventor: Gerald Lesko, Edmonton (CA)

(21) Appl. No.: 15/581,596

(22) Filed: Apr. 28, 2017

Related U.S. Application Data
(60) Provisional application No. 62/328,751, filed on Apr. 28, 2016.

(51) Int. Cl. E21B 19/00; B66D 1/12; B66D 1/22; B66D 1/28

(52) U.S. Cl. CPC E21B 19/008; B66D 1/28; B66D 1/12; B66D 1/22

(57) ABSTRACT

A cable drawworks for a drilling rig is provided having a tubular cable reel with an electric motor placed within the cable reel, and a speed reducing unit coupling the motor to the cable reel. The speed reducing unit can include a cycloidal gear mechanism or a ring gear mechanism. The drawworks can include an air pathway passing through the motor and the cable reel for cooling or for heating in cold weather applications.

### CROSS-REFERENCE TO RELATED APPLICATIONS

This application claims priority of U.S. provisional patent application Ser. No. 62/328,751 filed Apr. 28, 2016, which is incorporated by reference into this application in its entirety.

### TECHNICAL FIELD

The present disclosure is related to the field of winches, and cable drawworks mechanisms for use in raising and lowering traveling blocks within drilling rigs.

### BACKGROUND

Winches and cable drawworks mechanisms have been used in drilling rigs for decades. Winches and cable drawworks are, typically, motor-driven drums used to reel in or pay out a cable used on the drilling rig to raise or lower a traveling block within the rig. The cable will typically be used with pulleys and pulley blocks attached to the top of the rig and the traveling block, respectively. The traveling block is used for tripping pipe in and out a drill string, as well known to those skilled in the art. Various methods and devices have been developed for this purpose.

U.S. Pat. No. 2,505,088 issued to Athy teaches the use of two cable drums attached to either end of the cable coupled to a traveling block within a drilling rig through a series of pulleys. Having two drums doubles the speed that the cable can be reeled in or paid out resulting in doubling the speed that the traveling block can be raised or lowered within the drilling rig. The disadvantage of such a device is that two cable drums are required for this which increases the amount of space needed for the drums. Furthermore, additional drive train components are required for applying power from a motor to turn the two drums.

U.S. Pat. No. 4,438,904 issued to White teaches a drawworks mechanism that comprises a number of intermediary shafts having clutches that may engage or disengage power from an input drive shaft to the intermediary shaft. The mechanism consists of a number of chain and sprocket drive means for coupling rotation of power from one shaft to another. The disadvantage of this system is the physical space required to house such a mechanism on a drilling rig platform.

U.S. Pat. No. 6,182,945 issued to Dyer et al. teaches a complex drawworks mechanism comprising the use of redundant motors and gear transmissions for applying power to the cable drum. The disadvantage of this system is the significant size of the mechanism which necessitates that the mechanism be located apart and away from the drilling platform.

It is, therefore, desirable to provide winches and cable drawworks mechanisms that are compact enough so that it may be located directly on a drilling platform yet having sufficient power and braking ability to safely reel in and pay out cable for raising and lowering a traveling block within a drilling rig.

### SUMMARY

A cable drawworks mechanism for a drilling rig can be provided that overcomes the shortcomings identified in the prior art. In one embodiment, the drawworks can comprise a housing that has a footprint compact enough to allow it to be located on a drilling rig platform. The housing can comprise a tubular cable reel rotatably disposed in the housing wherein an electric motor can be mounted inside the cable reel. The motor can be coupled to the cable reel with a speed reduction unit. In some embodiments, the speed reduction unit can comprise a cycloidal gear mechanism that can reduce the motor rotation speed and, thus, multiply the torque that can be applied to rotated the cable reel. In another embodiment, a multi-stage ring gear mechanism can be used to couple the motor to the cable reel. In either embodiment, the drawworks can comprise an air pathway disposed through the housing and, in particular, through the motor in which cooled air can be blown therethrough to cool the motor under normal or hot weather conditions. In other embodiments, heated air can be blown through the motor to warm the motor and speed reduction unit when being operated in cold weather conditions.

Broadly stated, in some embodiments, a winch can be provided, comprising: a housing; a tubular cable reel rotatably disposed in the housing and capable of rotation therein, the cable reel configured for a cable to be spooled thereon, the cable reel further comprising a first side and a second side, and a motor cavity disposed therebetween within the cable reel; an electric motor disposed in the motor cavity, the motor comprising a motor shaft further comprising a first end and a second end; a speed reduction unit operatively coupling the first end of the motor shaft to the first side of the cable reel; a first support member operatively coupling the speed reduction unit to the housing; and a second support member operatively coupling the electric motor to the housing, wherein the second side of the cable reel is rotatably disposed around the second support member.

Broadly stated, in some embodiments, a cable drawworks can be provided for a drilling rig, the drawworks comprising: a housing adapted for mounting on a platform on the drilling rig; a tubular cable reel rotatably disposed in the housing and capable of rotation therein, the cable reel configured for a cable to be spooled thereon, the cable reel further comprising a first side and a second side, and a motor cavity disposed therebetween within the cable reel; an electric motor disposed in the motor cavity, the motor comprising a motor shaft further comprising a first end and a second end; a speed reduction unit operatively coupling the first end of the motor shaft to the first side of the cable reel; a first support member operatively coupling the speed reduction unit to the housing; and a second support member operatively coupling the electric motor to the housing, wherein the second side of the cable reel is rotatably disposed around the second support member.

Broadly stated, in some embodiments, the speed reduction unit can comprise a cycloidal speed reducer further comprising: a cycloidal drive housing rotatably supported by the first support member, the cycloidal drive housing operatively coupled to the first side of the cable reel, the cycloidal drive housing further comprising a plurality of plate rollers rotatably disposed therein, the cycloidal drive housing further comprising a plurality of eccentric rollers rotatably disposed therein; an eccentric shaft rotatably disposed in the cycloidal drive housing, the eccentric shaft configured for releasably engaging the first end of the motor shaft, the eccentric shaft further comprising at least one eccentric lobe; and at least one cycloidal plate rotatably disposed around the at least one eccentric lobe of the eccentric shaft, the at least one cycloidal plate comprising a plurality of openings configured for receiving the plurality of eccentric rollers, the at least one cycloidal plate further comprising a plurality of lobes disposed circumferentially therearound, the plurality of lobes configured for rotatably engaging the plate rollers when the eccentric shaft is rotated by the motor shaft.

Broadly stated, in some embodiments, the cycloidal speed reducer can comprise two cycloidal plates.

Broadly stated, in some embodiments, the speed reduction unit can comprise a ring gear speed reduction unit operatively coupling the first end of the motor shaft to the first side of the cable reel.

Broadly stated, in some embodiments, the winch or the cable drawworks can further comprise a brake mechanism for braking rotation of the cable reel.

Broadly stated, in some embodiments, the brake mechanism can further comprise at least one band brake configured for braking the rotation of at least one brake drum operatively coupled to the cable reel.

Broadly stated, in some embodiments, the brake mechanism can further comprise an armature brake mechanism operatively coupled to the second end of the motor shaft and configured for braking the rotation of the motor shaft.

Broadly stated, in some embodiments, the winch or the cable drawworks can further comprise an air pathway disposed through the housing, the air pathway providing communication from an inlet disposed near a first end of the housing to an outlet disposed near a second end of the housing, the air pathway passing through the motor cavity.

Broadly stated, in some embodiments, the winch or the cable drawworks can further comprise an air blower operatively coupled to the inlet of the air pathway, the air blower configured for blowing atmospheric air, cooled air or heated air through the air pathway.

Broadly stated, in some embodiments, the winch or the cable drawworks can further comprise a duct operatively coupling the air blower to the inlet of the air pathway.

### BRIEF DESCRIPTION OF THE DRAWINGS

FIG. 1 is a front elevation view depicting one embodiment of a cable drawworks.

FIG. 2 is a right side elevation view depicting the cable drawworks of FIG. 1.

FIG. 3 is a top plan view depicting the cable drawworks of FIG. 1.

FIG. 4 is a left side elevation view depicting the cable drawworks of FIG. 1.

FIG. 5 is a rear perspective view depicting the cable drawworks of FIG. 1.

FIG. 6 is a front perspective view depicting the cable drawworks of FIG. 1.

FIG. 7A is a front cross-section elevation view depicting the cable drawworks of FIG. 1.

FIG. 7B is a front cross-section elevation view depicting an alternate embodiment of the cable drawworks of FIG. 1

FIG. 8 is a front perspective exploded view depicting the cable drawworks of FIG. 7B1.

FIG. 9A is a front perspective partial exploded view depicting the cable drawworks of FIG. 7B.

FIG. 9B is a front perspective partial exploded view depicting the cable drawworks of FIG. 9A revealing a cycloidal plate gear reduction drive mechanism.

FIG. 9C is an end elevation view depicting the cable drawworks of FIG. 9B along cross-section view A-A, revealing the cycloidal plate gear reduction drive mechanism.

FIG. 9D is an end elevation view depicting the cycloidal plate gear reduction drive mechanism of FIG. 9C.

FIG. 9E is a front perspective partial exploded view depicting the cycloidal plate gear reduction drive mechanism of FIG. 9D.

FIG. 10 is a front perspective transparent view depicting a second embodiment of a cable drawworks.

FIG. 11 is a rear perspective view depicting the cable drawworks of FIG. 10.

FIG. 12A is a front cross-section elevation view depicting the cable drawworks of FIG. 1.

FIG. 12B is a front cross-section elevation view depicting the cable drawworks of FIG. 7B.

FIG. 13 is a front perspective exploded view depicting the cable drawworks of FIG. 10, revealing a ring gear drive mechanism.

FIG. 14 is an end elevation view depicting the cable drawworks of FIG. 12B, revealing a ring gear drive mechanism.

FIG. 15 is a front perspective view depicting the ring gear drive mechanism of FIG. 14.

FIG. 16 is a front perspective view depicting the ring gear drive mechanism of FIG. 15 with a support frame removed to reveal the drive gears.

FIG. 17 is a rear perspective view depicting the ring gear drive mechanism of FIG. 15.

FIG. 18 is a rear perspective view depicting the ring gear drive mechanism of FIG. 16.

### DETAILED DESCRIPTION OF EMBODIMENTS

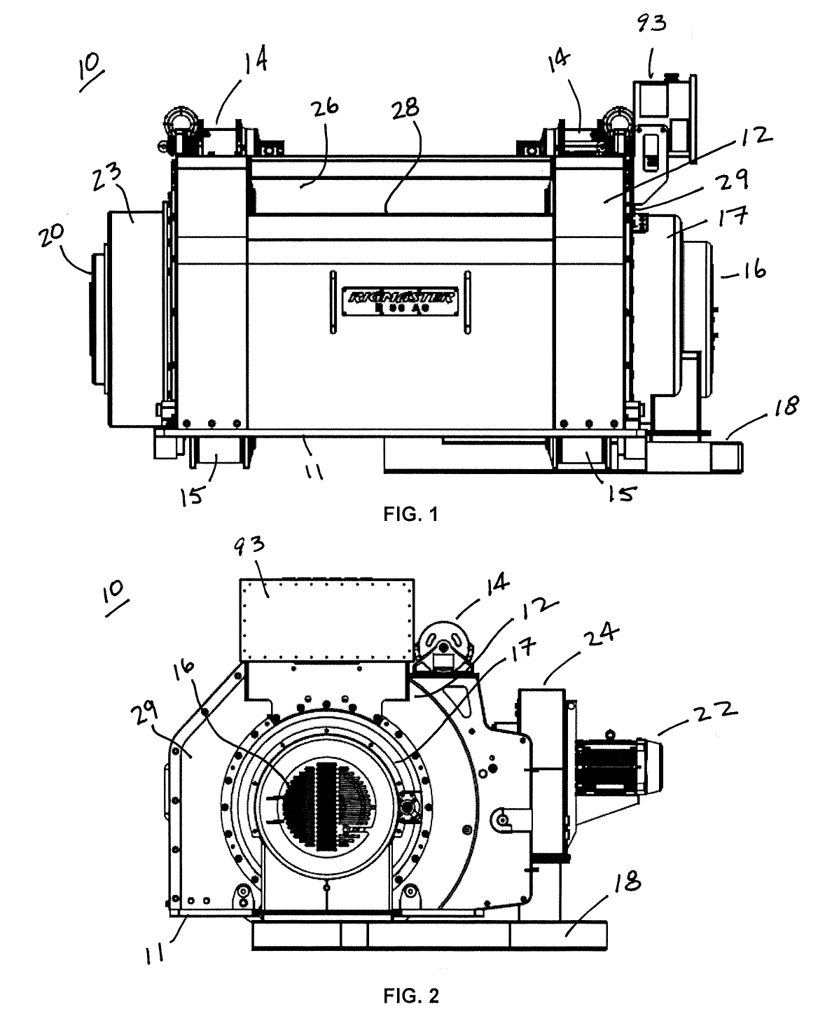

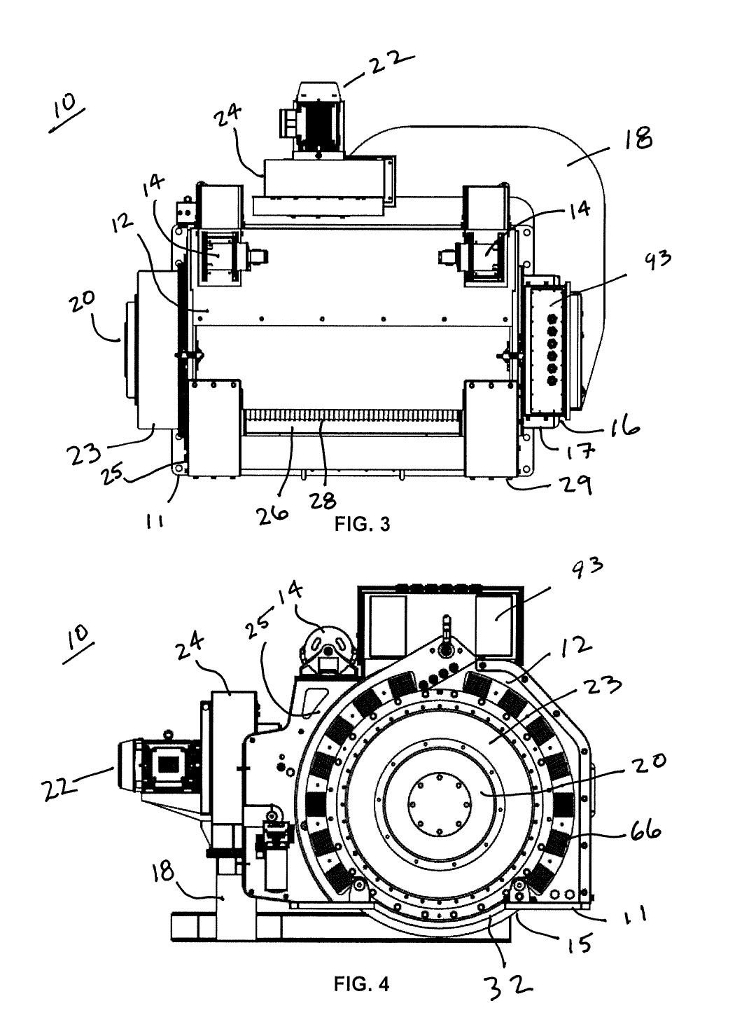

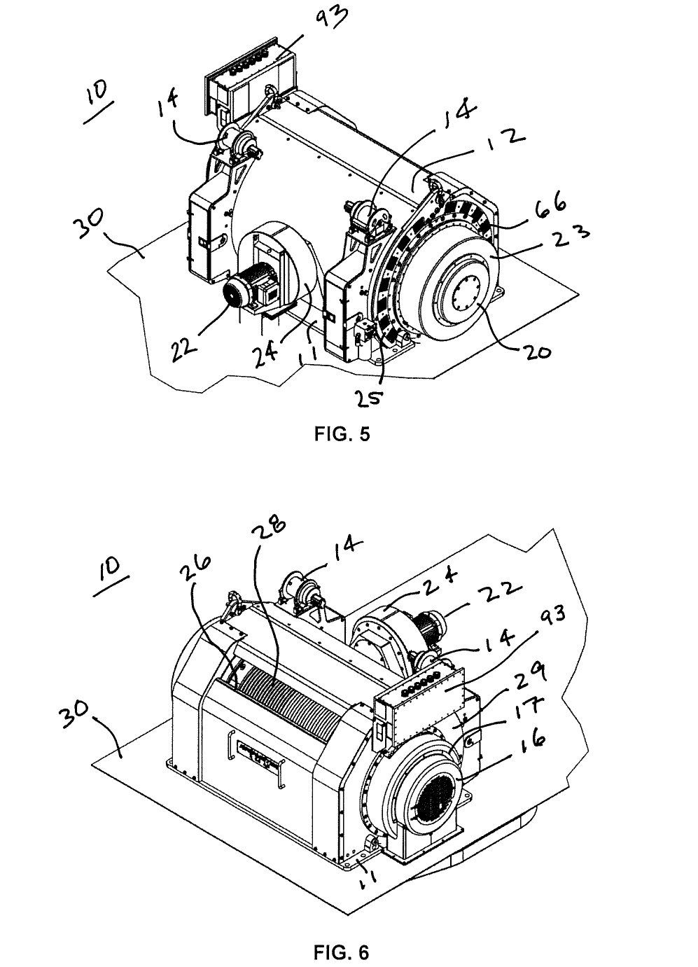

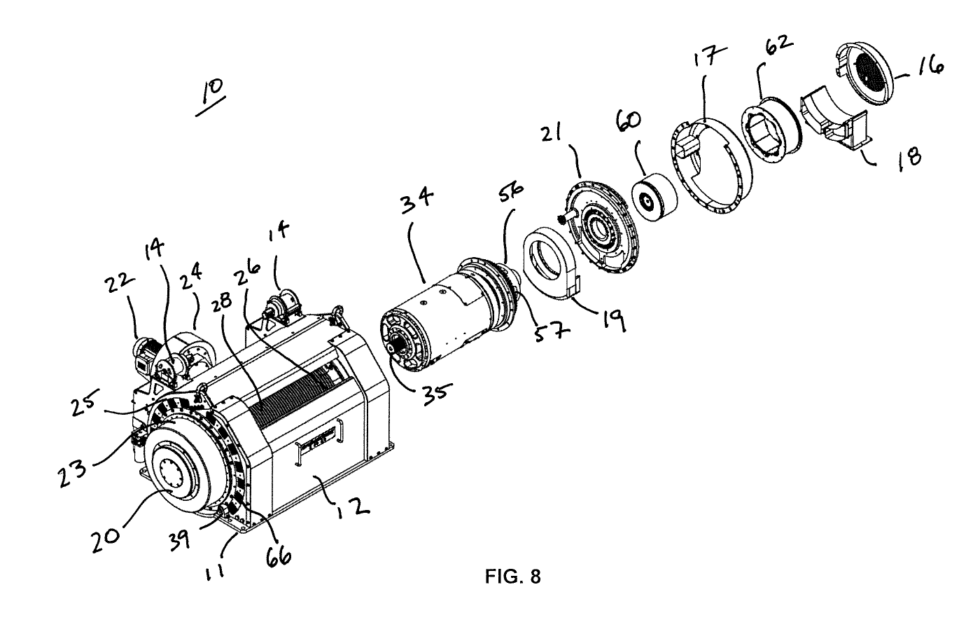

Referring to FIGS. 1 to 9E, one embodiment of cable drawworks 10 is shown. In this embodiment, drawworks 10 can comprise a cycloidal speed reducing unit as a means for coupling electrical motor 34 to tubular cable reel 28.

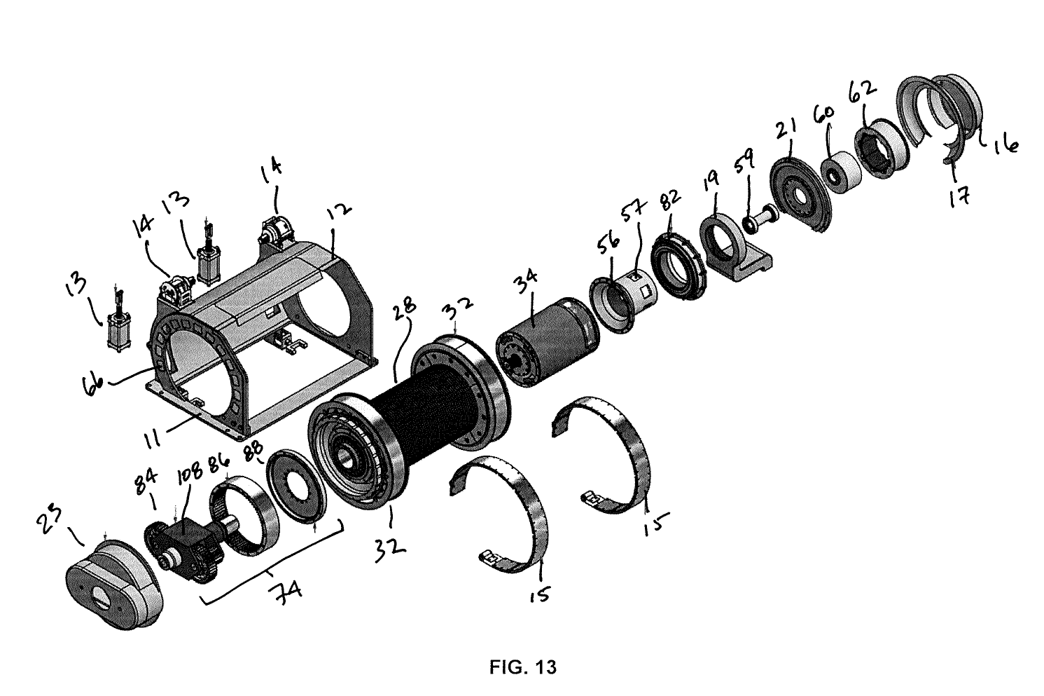

In some embodiments, drawworks 10 can comprise housing 12 disposed on top of baseplate 11 configured for attaching to skid floor 30, housing 12 comprising opening 26 to provide access to tubular cable reel 28 disposed rotatably therein. On one end of housing 12, drawworks 10 can comprise shroud 17 and end cap 16; on the other end, drawworks 10 can comprise shroud 23 and end cap 20. In some embodiments, drawworks 10 can further comprise brake mechanisms 14 and band brakes 15 disposed around brake drums 32 for braking the rotation of cable reel 28. Brake mechanisms 14 can be actuated by brake actuators 13 (as shown in FIG. 13). In some embodiments, drawworks 10 can comprise air duct 18 operatively coupling the interior of housing 12, via opening 27 disposed through shroud 17, to blower 24, which is operatively powered by electric motor 22. Blower 24 can provide a source of air for flowing through air pathway 64 via duct 18 and slots 57 into annulus 33 disposed inside motor 34, between rotor 38 and stator 40, to outlet chamber 37 and eventually exit through slots 66 disposed through end wall 25. In some embodiments, blower 24 can draw in air from the atmosphere for circulation through drawworks 10. In other embodiments, blower 24 can comprise air cooling means (not shown), such as a refrigeration system or such other mechanisms well known to those skilled in the art, to cool atmospheric air before circulation through drawworks 10 when it is being operated in a hot weather environment. In yet further embodiments, blower 24 can comprise air heating means (not shown), such as an heating element or a heat exchanger or such other means well known to those skilled in the art, for heating or warming drawworks 10 when it is being operated in a cold weather environment.

In some embodiments, drawworks 10 can comprise electric motor 34 can be supported within cable reel 28 at one end by support member 56 operatively coupled to end plate 21 disposed on end wall 29 of housing 12. In some embodiments, motor 34 can comprise a 3-phase alternating current induction force-ventilated electric motor as manufactured by companies such as Ward Leonard Electric Co. Ltd. of Thomaston, Conn., U.S.A., Amerimex Inc. of Houston, Tex., U.S.A. or Breuer Motoren Gmbh of Bochum, Germany. In some embodiments, motor 34 can comprise a power rating in the 1000 to 3000 horsepower range. Electrical power can be routed to motor 34 from electrical power cables supplying 3-phase electricity power (not shown) into electrical junction box 93 disposed on drawworks 10.

In some embodiments, one end of motor shaft 35 of motor 34 can operatively couple with coupler 59 disposed within support member 56, wherein coupler 59 can be attached to brake drum 60 for operation with armature brake 62, which can all be enclosed within shroud 17 and end cap 16. Armature brake 62 can be provided as an additional brake for drawworks 10. Air duct 18 can terminate with shroud 19 disposed around support member 56 for communication with slots 57 disposed through support member 56. In some embodiments, cable reel 28 can be rotatably disposed around support member 56 via reel plate 43 operatively coupled to hub 82 that can be further disposed around roller bearing mechanism 58.

In some embodiments, motor 34 can be coupled to cable reel 28 via cycloid gear reducer 36. In some embodiments, cycloid gear reducer 36 can comprise model no. 11-1 CYC cycloid mechanism as manufactured by Rigmaster Machinery Ltd. Edmonton, Alberta, Canada or such other equivalent cycloid gear mechanism as well known to those skilled in the art. Motor 34 can be coupled cable reel 28 by inserting motor shaft 35 into opening 67 of eccentric shaft 48. Gear reducer 36 can further comprise cycloid plates 52 disposed within housing 54, wherein cycloid plates 52 can be rotatably disposed around eccentric lobes 51 on eccentric shaft 48. Shaft 48 can be rotatably disposed within tubular shaft 44 via bearing 50, wherein shaft 44 can be rotatably disposed in drive housing 47 via bearing 49, wherein housing 47 can be further rotatably disposed in support member 45 via bearing 46. These mechanisms can be enclosed by shroud 23 and end cap 20. In an example where cycloid plates 52 provide a 11:1 gear reduction, the amount of torque that can be applied to rotate cable reel 28 can be, theoretically, eleven times the torque output of motor 34. In some embodiments, the combination of motor 34 and cycloid gear reducer 36 can provide torque to cable reel 28 in the range of 50,000 to 200,000 foot-pounds (“ft-lbs”).

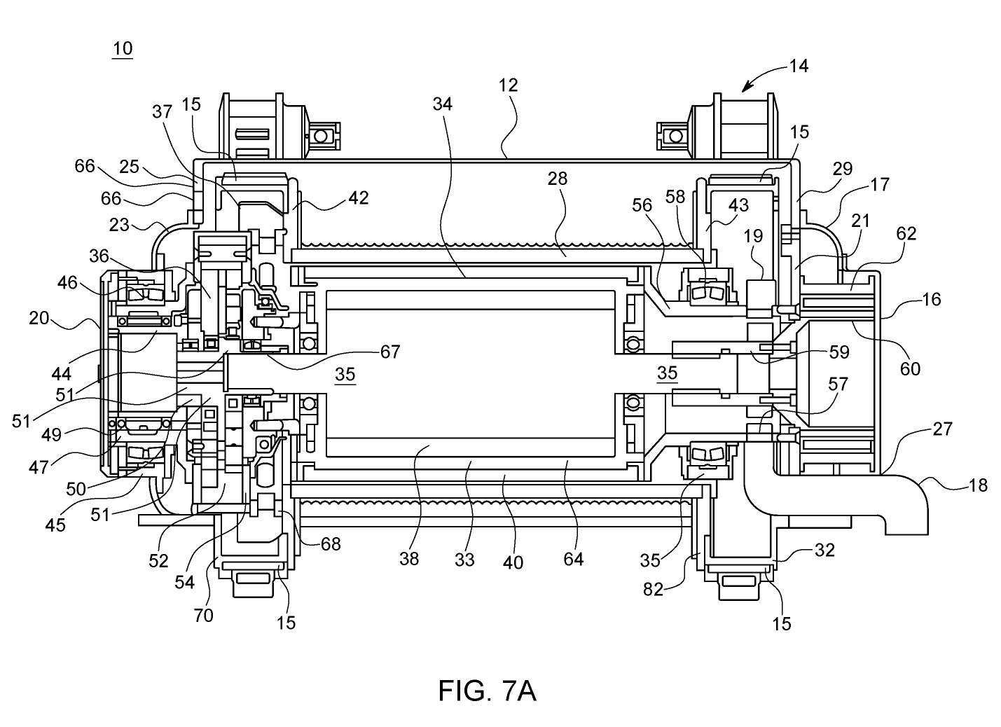

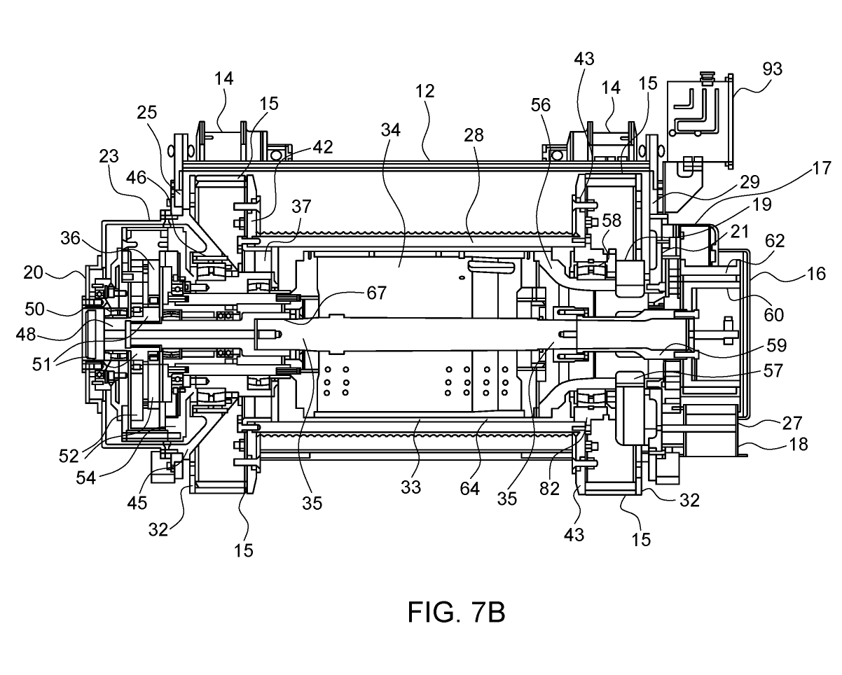

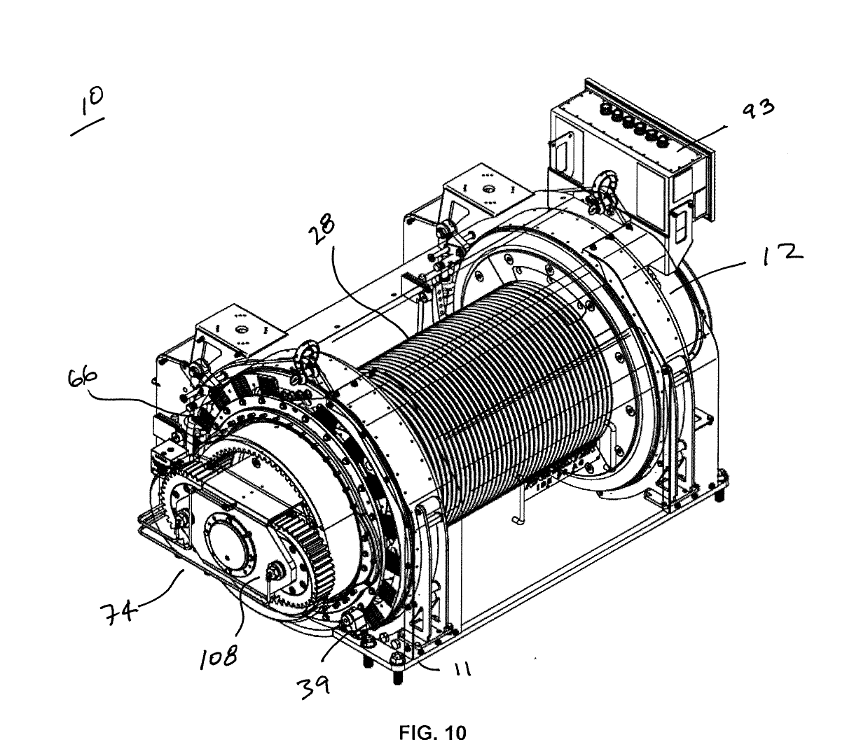

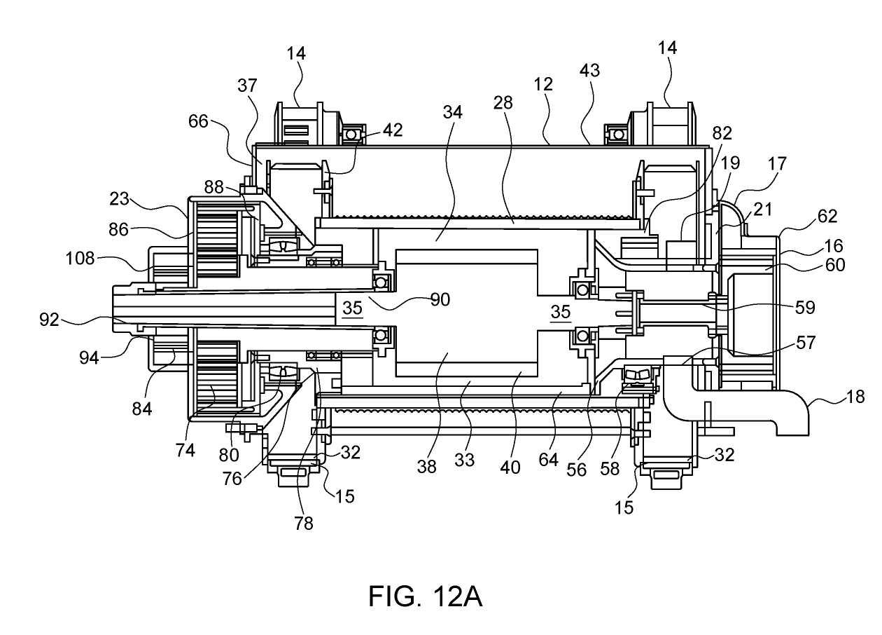

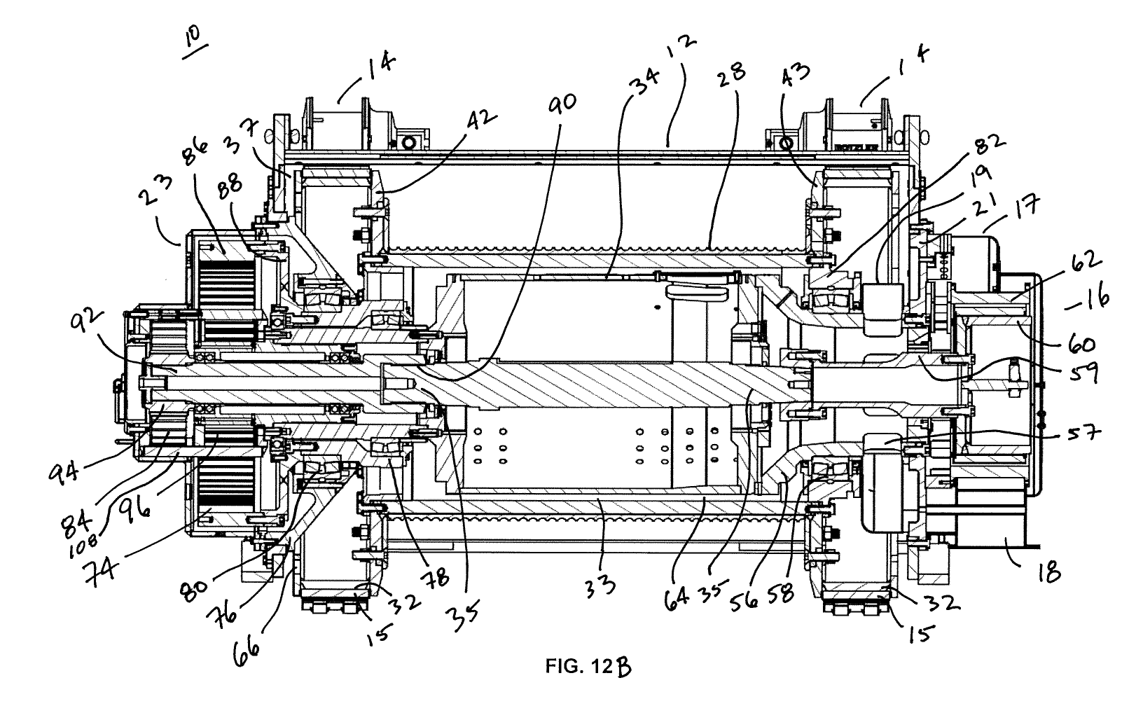

Referring to FIG. 7A, one embodiment of drawworks 10 is shown where cycloid gear reducer 36 is positioned on the internal side of end wall 25 and, thus, in close proximity to motor 34. In FIG. 7B, another embodiment of drawworks 10 is shown where cycloid gear reducer 36 is disposed further away from motor 34 compared to FIG. 7A, and positioned on the external side of end wall 25. In this embodiment, drawworks 10 can comprise internal rotating mechanism for coupling motor 34 to cable reel 28 that are similar to the internal rotating mechanism used in the ring gear embodiment of drawworks 10 shown in FIGS. 10, 12A and 12B. In some embodiments, the embodiment of drawworks 10 shown in FIG. 7B can comprise a different physical configuration of air duct 18, as shown in FIG. 7B, but which still functions in a similar fashion to the embodiment of drawworks 10 shown in FIG. 7A.

In some embodiments, gear reducer housing 54 can be operatively coupled to reel plate 42 via disc coupler 68. Coupler 68 can comprise a plurality of slots 70 disposed through a circumferential sidewall thereof wherein slots 70 can provide communication between annulus 33 and outlet chamber 37 when motor 34 is operating and, thus, when disc coupler 68 is rotating to rotate cable reel 28. When drawworks 10 is not operating, cable reel 28 can be locked into position to prevent rotation thereof by lock pins 39 being operated to engage brake drum 32 within housing 12.

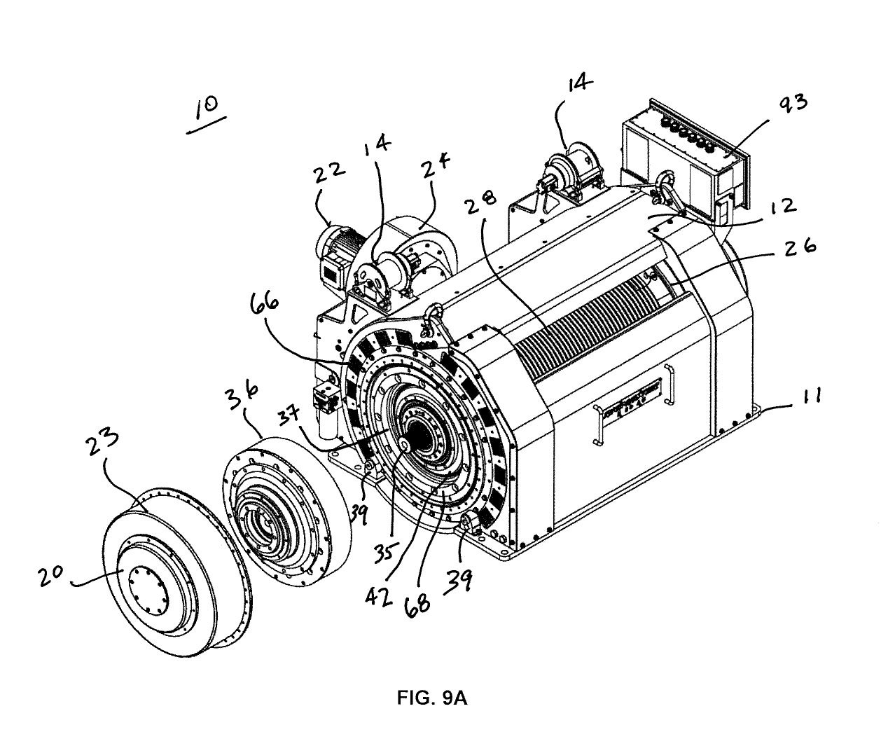

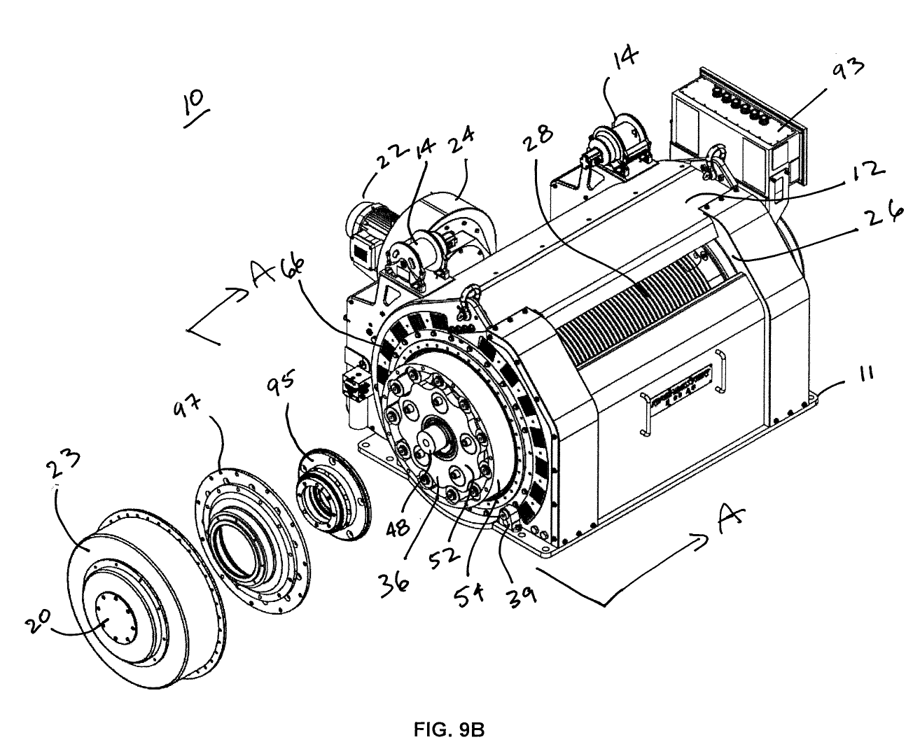

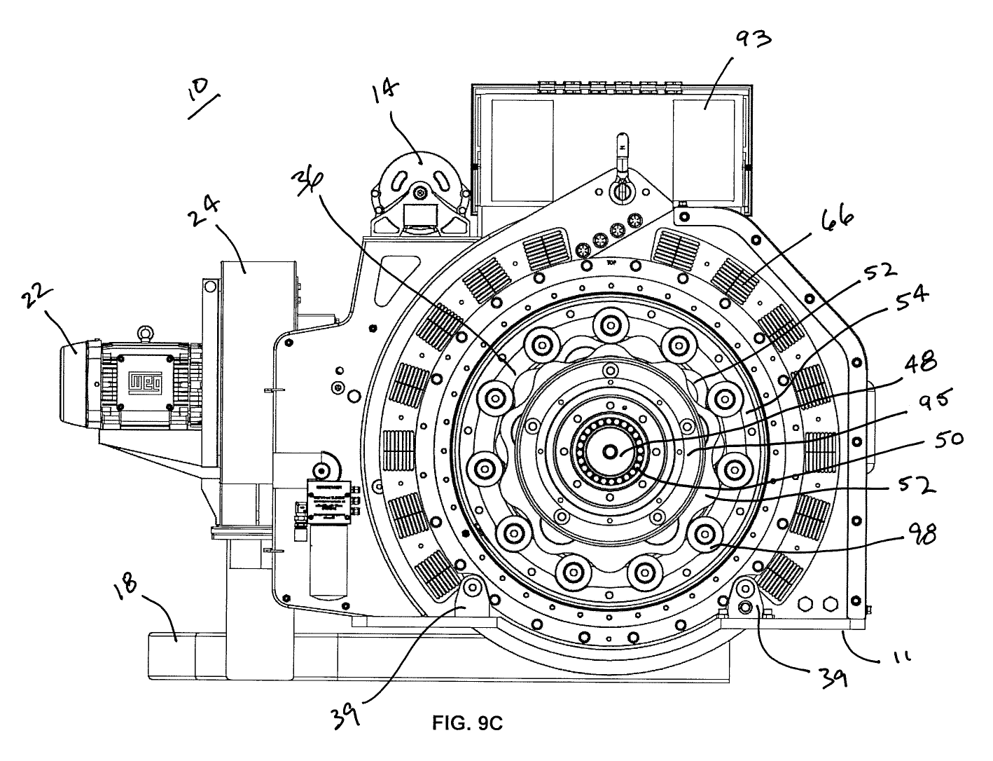

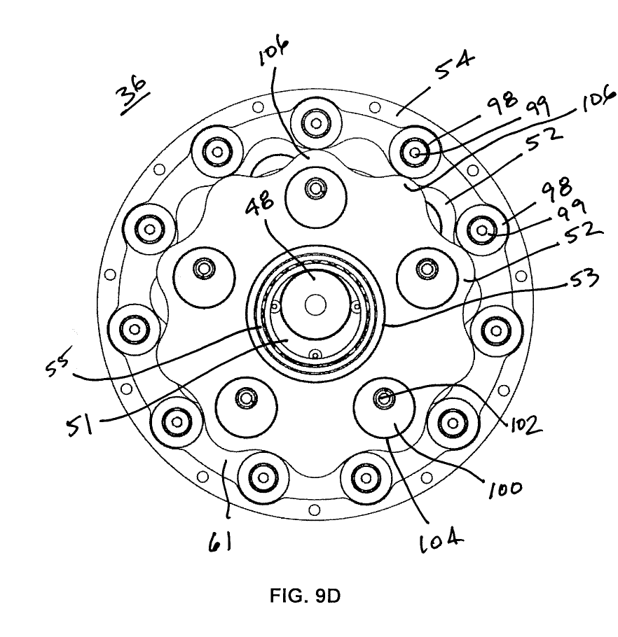

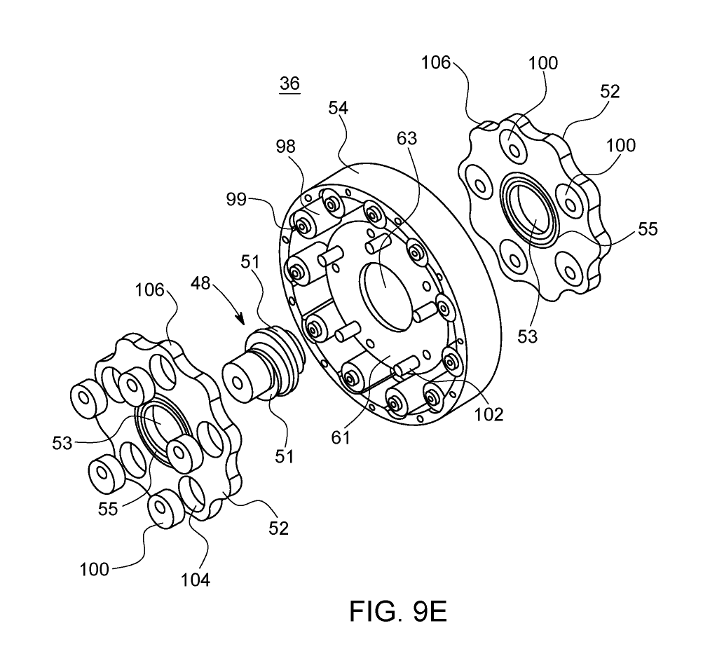

Referring to FIGS. 9A to 9E, an embodiment of drawworks 10 comprising cycloid gear reducer 36 is shown. In this embodiment, cycloid plates 52 comprise 10 of lobes 106, whereas reducer housing 54 comprise 11 of plate rollers 98 to provide a 10:1 gear reduction ratio for cycloid gear reducer 36. In some embodiments, cycloid gear reducer can comprise two cycloid plates 52 offset relative to each other. Each cycloid plate 52 can comprise opening 53 disposed therethrough where opening 53 is configured to receive annular bearing 55 further configured to cooperatively and rotatably fit with lobe 51 of eccentric shaft 48. In addition, each cycloid plate 52 can comprise a plurality of openings 104 disposed therethrough, each opening 104 configured to rotate about one of a plurality of eccentric rollers 100. In some embodiments, each eccentric roller 100 can rotate about one of a plurality of roller bearing pins 102 extending substantially perpendicularly from planar surface 61 of reducer housing 54. Each of plate rollers 98 can rotate about one of a plurality of roller pins 99 extending substantially perpendicular to planar surface 61. In some embodiments, reducer housing 54 can comprise a cycloid plate 52 on either side, each plate 52 with its requisite complement of plate rollers 98, roller pins 99, eccentric rollers 100 and roller bearing pins 102. Once assembled, eccentric shaft 48 can be disposed within opening 63, with lobes 51 further disposed in openings 53 of cycloid plates 52. When eccentric shaft 48 is coupled to motor shaft 35, rotation of motor shaft 35 causes eccentric shaft 48 to rotate and, thus, lobes 51 to rotate within openings 53 of cycloid plates 52. Cycloid plates 52 rotate about eccentric rollers 100 and plate rollers 98 and, thus, cause reducer housing 54 to rotate at a reduced rate. In the illustrated example, the gear reduction rate is 10:1. In some embodiments, reducer housing 54 can be operatively coupled to cable reel 28. Therefore, when motor shaft 35 rotates, cable reel 28 can rotate at one-tenth of the angular velocity of motor shaft 35.

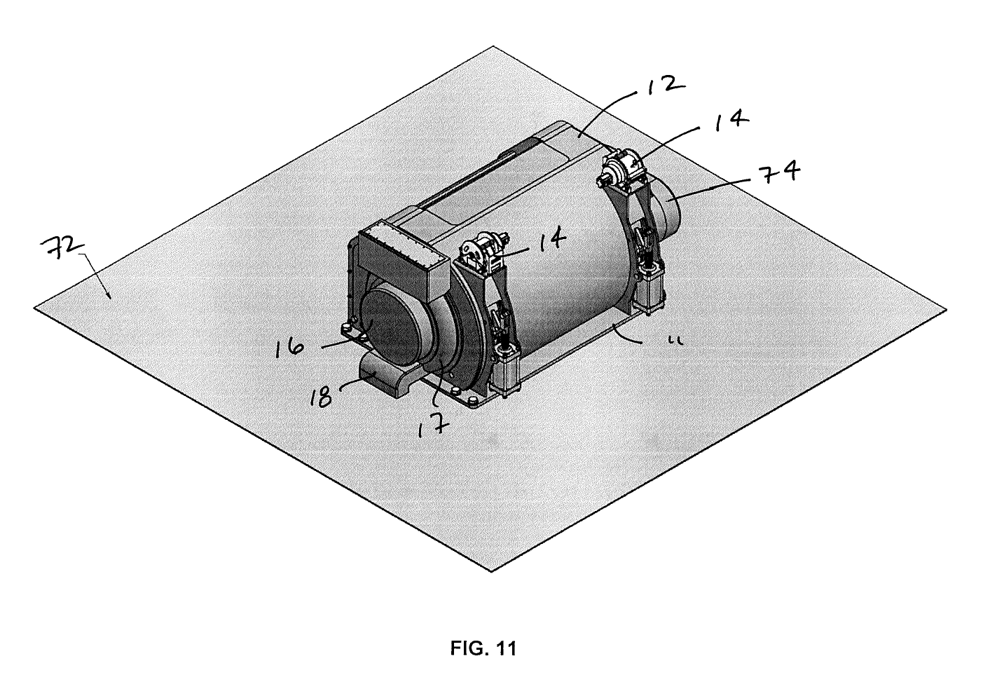

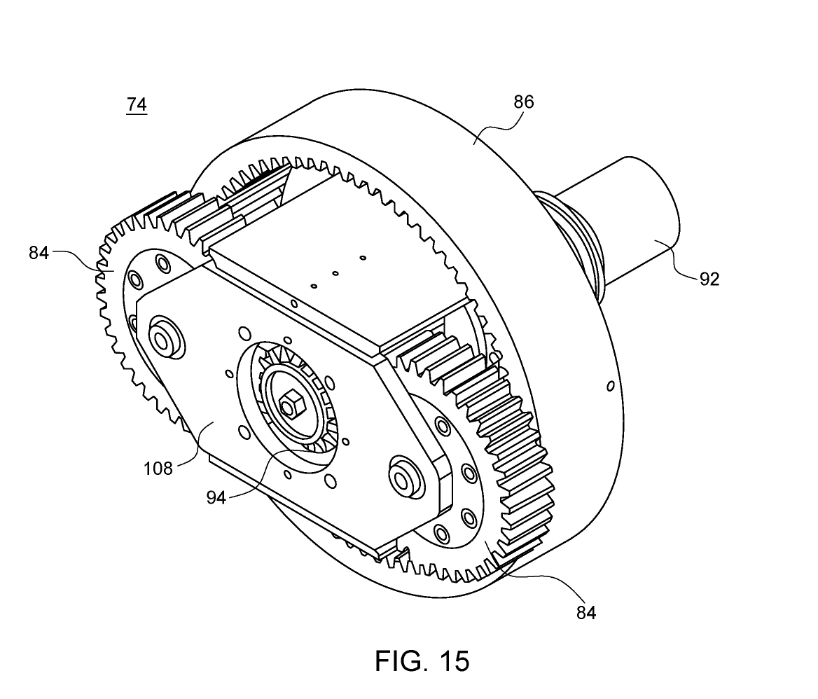

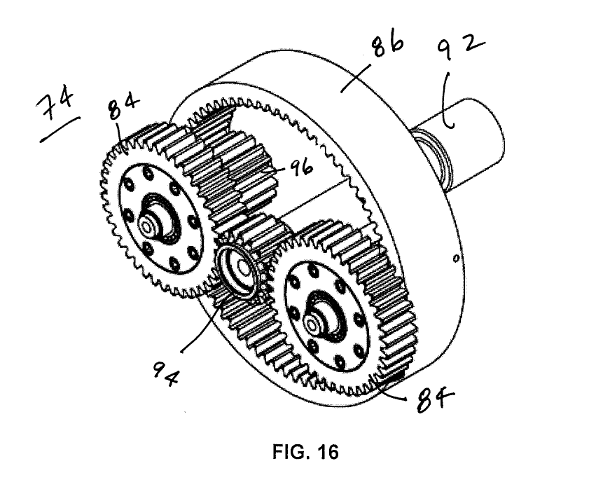

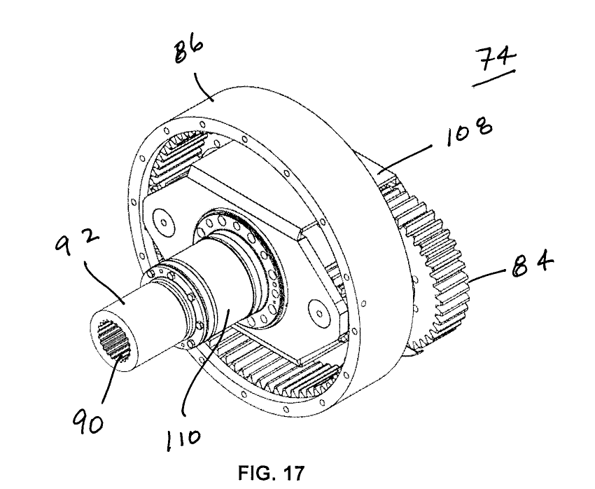

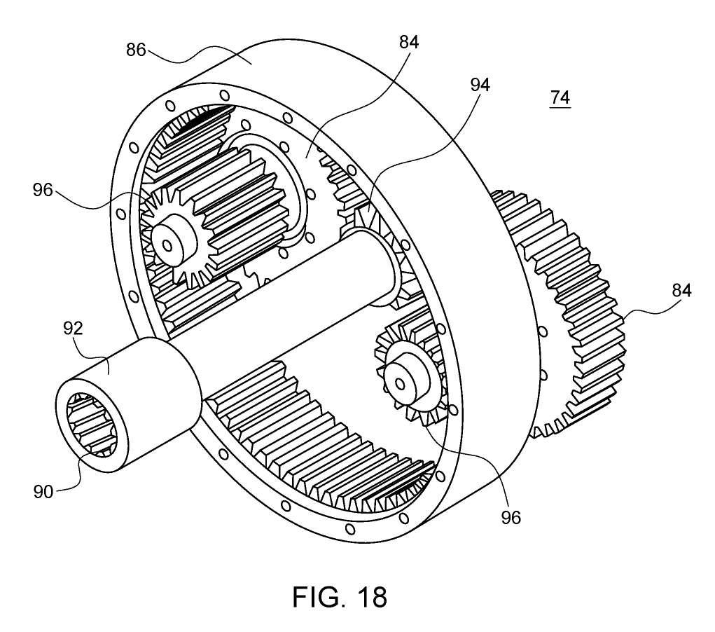

Referring to FIGS. 10 to 18, another embodiment of drawworks 10 is shown. In this embodiment, motor 34 can be coupled to cable reel 28 via ring gear mechanism 74 in place of cycloid gear reducer 36. In some embodiments, motor shaft 35 can be inserted into opening 90 of coupler shaft 92. Coupler shaft 92 can comprise pinion gear 94 configured to engage gears 84 rotatably disposed in support frame 108. Gears 84 can, in turn, can rotate drive gears 96 that can then engage ring gear 86. Ring gear 86 can be coupled to drive plate 88 that can be further coupled to coupler 78 that can form a hub operatively coupled to reel plate 42 of cable reel 28, thus coupling motor shaft 35 to cable reel 28. In some embodiments, support member 78 can be rotatably disposed in support member 76 via bearing 80.

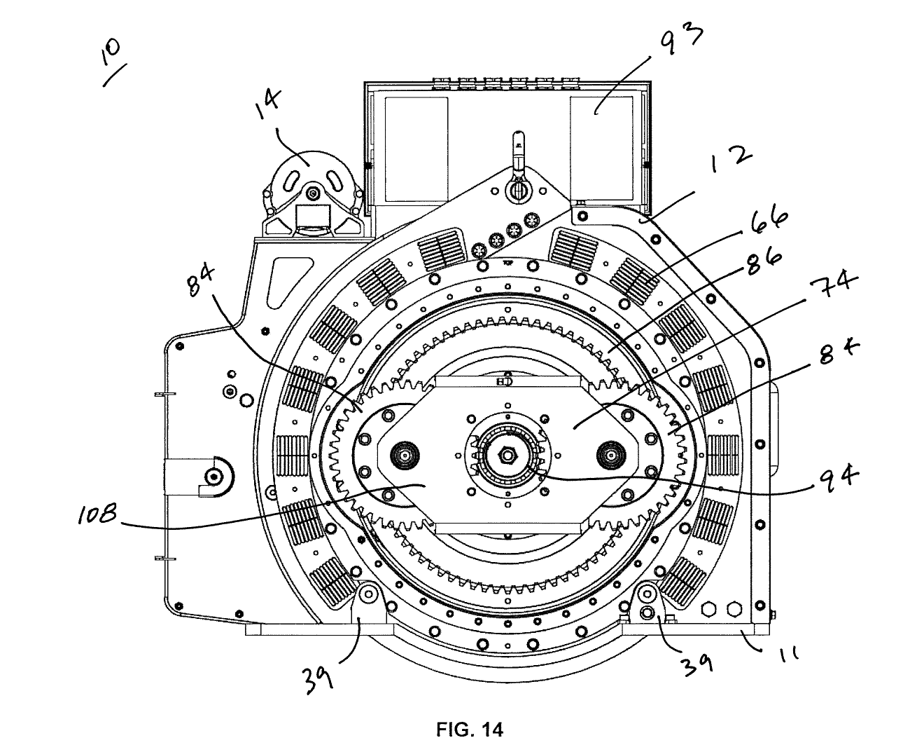

Referring to FIGS. 14 to 18, the relationship of gears 94, 84 and 96, and ring gear 86 can be seen. In the illustrated embodiment, pinion gear 94 can comprise 17 teeth, whereas gear 84 can comprise 39 teeth to provide a gear ratio of approximately 2.294:1. In the illustrated embodiment, gear 96 can comprise 17 teeth and ring gear 86 can comprise 73 teeth to provide a gear ratio of approximately 4.294:1. Thus, when combined together in support frame 108, the overall gear ratio provided by this combination of gears can be approximately 9.851:1. In the illustrated embodiment, the maximum power and torque that can be applied to pinion gear 94 can be 3046 hp and 16,000 ft-lbs, respectively, at an input speed of 1000 rpm. With respect to gears 84 and 96, the maximum power and torque that can be applied to gears 84 and 96 can be 2985 hp and 35,971 ft-lbs, respectively, at a speed of 436 rpm. With respect to ring gear 86, the maximum power and torque that can be applied to ring gear 86 can be 2926 hp and 151,374 ft-lbs, respectively, at a speed of 101 rpm.

In operation, motor 34 can be operated using any suitable motor control unit well known to those skilled in the art, such as a variable frequency drive motor controller or other suitable motor controller. In the event that motor 34 fails or burns out from extended service or other factors for either embodiment described herein, end cap 16 and shroud 17 can be removed to access motor 34. Upon removing end plate 21 from housing 12, motor 34 can be extracted from drawworks 10 to be replaced by a new motor unit. This configuration can permit service of drawworks 10 on a drilling site without removing drawworks 10 to take to an off-site repair facility thereby minimizing the down-time of the drilling rig in the event of a motor failure.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A winch, comprising:
a) a housing;
b) a tubular cable reel rotatably disposed in the housing and capable of rotation therein, the cable reel configured for a cable to be spooled thereon, the cable reel further comprising a first side and a second side, and a motor cavity disposed therebetween within the cable reel;
c) an electric motor disposed in the motor cavity, the motor comprising a motor shaft further comprising a first end and a second end;
d) a speed reduction unit operatively coupling the first end of the motor shaft to the first side of the cable reel;
e) a first support member operatively coupling the speed reduction unit to the housing; and
f) a second support member operatively coupling the electric motor to the housing, wherein the second side of the cable reel is rotatably disposed around the second support member.

2. The winch as set forth in claim 1, wherein the speed reduction unit comprises a cycloidal speed reducer further comprising:
a) a cycloidal drive housing rotatably supported by the first support member, the cycloidal drive housing operatively coupled to the first side of the cable reel, the cycloidal drive housing further comprising a plurality of plate rollers rotatably disposed therein, the cycloidal drive housing further comprising a plurality of eccentric rollers rotatably disposed therein;
b) an eccentric shaft rotatably disposed in the cycloidal drive housing, the eccentric shaft configured for releasably engaging the first end of the motor shaft, the eccentric shaft further comprising at least one eccentric lobe; and
c) at least one cycloidal plate rotatably disposed around the at least one eccentric lobe of the eccentric shaft, the at least one cycloidal plate comprising a plurality of openings configured for receiving the plurality of eccentric rollers, the at least one cycloidal plate further comprising a plurality of lobes disposed circumferentially therearound, the plurality of lobes configured for rotatably engaging the plate rollers when the eccentric shaft is rotated by the motor shaft.

3. The winch as set forth in claim 2, further comprising two cycloidal plates.

4. The winch as set forth in claim 1, wherein the speed reduction unit comprises a ring gear speed reduction unit operatively coupling the first end of the motor shaft to the first side of the cable reel.

5. The winch as set forth in claim 1, further comprising a brake mechanism for braking rotation of the cable reel.

6. The winch as set forth in claim 5, wherein the brake mechanism comprises at least one band brake configured for braking the rotation of at least one brake drum operatively coupled to the cable reel.

7. The winch as set forth in claim 5, wherein the brake mechanism comprises an armature brake mechanism operatively coupled to the second end of the motor shaft and configured for braking the rotation of the motor shaft.

8. The winch as set forth in claim 1, further comprising an air pathway disposed through the housing, the air pathway providing communication from an inlet disposed near a first end of the housing to an outlet disposed near a second end of the housing, the air pathway passing through the motor cavity.

9. The winch as set forth in claim 8, further comprising an air blower operatively coupled to the inlet of the air pathway, the air blower configured for blowing atmospheric air, cooled air or heated air through the air pathway.

10. The winch as set forth in claim 9, further comprising a duct operatively coupling the air blower to the inlet of the air pathway.

11. A cable drawworks for a drilling rig, the drawworks comprising:
a) a housing adapted for mounting on a platform on the drilling rig;
b) a tubular cable reel rotatably disposed in the housing and capable of rotation therein, the cable reel configured for a cable to be spooled thereon, the cable reel further comprising a first side and a second side, and a motor cavity disposed therebetween within the cable reel;
c) an electric motor disposed in the motor cavity, the motor comprising a motor shaft further comprising a first end and a second end;
d) a speed reduction unit operatively coupling the first end of the motor shaft to the first side of the cable reel;
e) a first support member operatively coupling the speed reduction unit to the housing; and
f) a second support member operatively coupling the electric motor to the housing, wherein the second side of the cable reel is rotatably disposed around the second support member.

12. The drawworks as set forth in claim 11, wherein the speed reduction unit comprises a cycloidal speed reducer further comprising:
a) a cycloidal drive housing rotatably supported by the first support member, the cycloidal drive housing operatively coupled to the first side of the cable reel, the cycloidal drive housing further comprising a plurality of plate rollers rotatably disposed therein, the cycloidal drive housing further comprising a plurality of eccentric rollers rotatably disposed therein;
b) an eccentric shaft rotatably disposed in the cycloidal drive housing, the eccentric shaft configured for releasably engaging the first end of the motor shaft, the eccentric shaft further comprising at least one eccentric lobe; and
c) at least one cycloidal plate rotatably disposed around the at least one eccentric lobe of the eccentric shaft, the at least one cycloidal plate comprising a plurality of openings configured for receiving the plurality of eccentric rollers, the at least one cycloidal plate further comprising a plurality of lobes disposed circumferentially therearound, the plurality of lobes configured for rotatably engaging the plate rollers when the eccentric shaft is rotated by the motor shaft.

13. The drawworks as set forth in claim 12, further comprising two cycloidal plates.

14. The drawworks as set forth in claim 11, wherein the speed reduction unit comprises a ring gear speed reduction unit operatively coupling the first end of the motor shaft to the first side of the cable reel.

15. The drawworks as set forth in claim 11, further comprising a brake mechanism for braking rotation of the cable reel.

16. The drawworks as set forth in claim 15, wherein the brake mechanism comprises at least one band brake configured for braking the rotation of at least one brake drum operatively coupled to the cable reel.

17. The drawworks as set forth in claim 15, wherein the brake mechanism comprises an armature brake mechanism operatively coupled to the second end of the motor shaft and configured for braking the rotation of the motor shaft.

18. The drawworks as set forth in claim 11, further comprising an air pathway disposed through the housing, the air pathway providing communication from an inlet disposed near a first end of the housing to an outlet disposed near a second end of the housing, the air pathway passing through the motor cavity.

19. The drawworks as set forth in claim 18, further comprising an air blower operatively coupled to the inlet of the air pathway, the air blower configured for blowing atmospheric air, cooled air or heated air through the air pathway.

20. The drawworks as set forth in claim 19, further comprising a duct operatively coupling the air blower to the inlet of the air pathway.
